(19) United States
(12) Patent Application Publication
(10) Pub. No.: US 2008/0211945 A1
(43) Pub. Date: Sep. 4, 2008

(54) Image sensor with extended dynamic range

(76) Inventors: Jong-Wook Hong, Seoul (KR); Chan Park, Yongin-si (KR); Sang-Il Jung, Seoul (KR)

Correspondence Address: LAW OFFICE OF MONICA H CHOI, P O BOX 3424, DUBLIN, OH, 430160204, US

(21) Appl. No.: 12/006,763

(22) Filed: Jan. 4, 2008

(30) Foreign Application Priority Data
Jan. 10, 2007 (KR) 2007-0002978

(51) Int. Cl. H04N 3/14

(52) U.S. Cl. 348/294

(57) ABSTRACT

An image sensor includes a first sub-pixel, a second sub-pixel, and an image processor. The first sub-pixel generates a first image signal with a first sensitivity, and the second sub-pixel generates a second image signal with a second sensitivity less than the first sensitivity. The image signal processor adds a change in the second image signal from a saturation level to the first image signal to generate a final image signal when the first sub-pixel is saturated.

This application claims priority under 35 USC § 119 to Korean Patent Application No. 2007-0002978, filed on Jan. 10, 2007 in the Korean Intellectual Property Office, the disclosure of which is incorporated herein in its entirety by reference.

### BACKGROUND OF THE INVENTION

1. Field of the Invention

The present invention relates generally to image sensors, and more particularly, to an image sensor having an extended dynamic range.

2. Background of the Invention

An image sensor converts an image into electrical signals, and is widely used for many applications such as in digital cameras. The image sensor includes a pixel array, i.e., a plurality of pixels arranged in a matrix configuration. Each pixel includes a photodiode for generating signal charges from incident photons, and includes devices for transferring and outputting the signal charges generated by the photodiode.

The quality of the image sensor is indicated by many characteristics, such as a dynamic range, sensitivity, responsiveness, uniformity, shuttering, speed, and noise. When an image of an object is captured under high illumination intensity using the image sensor, the dynamic range is particularly important. For example, when a bright object is shot at night, the object in the captured image may be difficult to recognize when the image sensor does not have an extended dynamic range.

### SUMMARY OF THE INVENTION

Accordingly, an image sensor is formed with compensation sub-pixels for extending the dynamic range of the image sensor.

An image sensor according to an aspect of the present invention includes a first sub-pixel, a second sub-pixel, and an image processor. The first sub-pixel generates a first image signal with a first sensitivity, and the second sub-pixel generates a second image signal with a second sensitivity less than the first sensitivity. The image signal processor adds a change in the second image signal from a saturation level to the first image signal to generate a final image signal when the first sub-pixel is saturated.

In an example embodiment of the present invention, the image signal processor includes a data processor and a memory device having sequences of instructions stored thereon. Execution of the sequences of instructions by the data processor causes the data processor to perform the steps of:

determining that the first sub-pixel is saturated when the first image signal reaches a saturation level; and

adding the change in the second image signal from the saturation level to the first image signal to generate the final image signal when the first sub-pixel is saturated.

In a further embodiment of the present invention, execution of the sequences of instructions by the data processor causes the data processor to perform the further step of:

using the first image signal as the final image signal when the first sub-pixel is not saturated.

In another embodiment of the present invention, execution of the sequences of instructions by the data processor causes the data processor to perform the further step of:

determining that the first sub-pixel is not saturated when the first image signal is less than the saturation level.

In an example embodiment of the present invention, a first light receiving area of the first sub-pixel is smaller than a second light receiving area of the second sub-pixel. For example, a first opening formed through a first interconnection over a first light receiving junction for the first sub-pixel is smaller than a second opening formed through a second interconnection over a second light receiving junction for the second sub-pixel.

In a further embodiment of the present invention, light received by the second light receiving junction is of different color from light received by the first light receiving junction. For example, a first light filter is disposed over the first light receiving junction, and no light filter is disposed over the second light receiving junction. Alternatively, a first light filter is disposed over the first light receiving junction, and a second light filter is disposed over the second light receiving junction, with the first and second light filters passing different color components.

In another embodiment of the present invention, a first micro-lens is formed for the first sub-pixel, and no micro-lens is formed for the second sub-pixel. Alternatively, a first micro-lens is formed for the first sub-pixel, and a second micro-lens is formed for the second sub-pixel, with the first micro-lens having a first condensing rate that is higher than a second condensing rate of the second micro-lens. For example, a first size of the first micro-lens is larger than a second size of the second micro-lens.

In a further embodiment of the present invention, the image sensor also includes a third sub-pixel and a fourth sub-pixel. The third sub-pixel generates a third image signal with a third sensitivity, and the fourth sub-pixel generates a fourth image signal with a fourth sensitivity. Each of the third and fourth sensitivities is higher than the second sensitivity. For example, the first sub-pixel is for sensing red light, the second sub-pixel is for sensing one of white light and green light, the third sub-pixel is for sensing green light, and the fourth sub-pixel is for sensing blue light.

In that case, the image signal processor adds the change in the second image signal from the saturation level to the first image signal to generate a first final image signal when the first sub-pixel is saturated. In addition, the image signal processor adds the change in the second image signal from the saturation level to the third image signal to generate a third final image signal when the third sub-pixel is saturated. Furthermore, the image signal processor adds the change in the second image signal from the saturation level to the fourth image signal to generate a fourth final image signal when the fourth sub-pixel is saturated. Additionally, a pattern of the first, second, third, and fourth sub-pixels together forming a main pixel is repeated to form an image sensor array.

In this manner, the second sub-pixel having lower sensitivity acts as a compensation sub-pixel of the main pixel for extending the dynamic range of the main pixel. Thus, an object illuminated with high light intensity may be effectively captured with the image sensor.

### BRIEF DESCRIPTION OF THE DRAWINGS

The above and other features and advantages of the present invention will become more apparent when described in detailed exemplary embodiments thereof with reference to the attached drawings in which:

FIG. 1 is a plan view of an image sensor, according to an example embodiment of the present invention;

FIG. 2 is a cross-sectional view along the lines I-I′ in the image sensor of FIG. 1, according to an example embodiment of the present invention;

FIG. 3 is a cross-sectional view along the lines I-I′ in the image sensor of FIG. 1, according to another example embodiment of the present invention;

FIG. 4 is a cross-sectional view along the lines I-I′ in the image sensor of FIG. 1, according to another example embodiment of the present invention;

FIG. 5 shows plots of signal levels versus illumination intensity for sub-pixels of FIG. 1, according to an example embodiment of the present invention;

FIG. 6 shows further components such as an image signal processor for the image sensor of FIG. 1, according to an example embodiment of the present invention; and

FIG. 7 shows a flowchart of steps during operation of the image signal processor of FIG. 6, according to an example embodiment of the present invention.

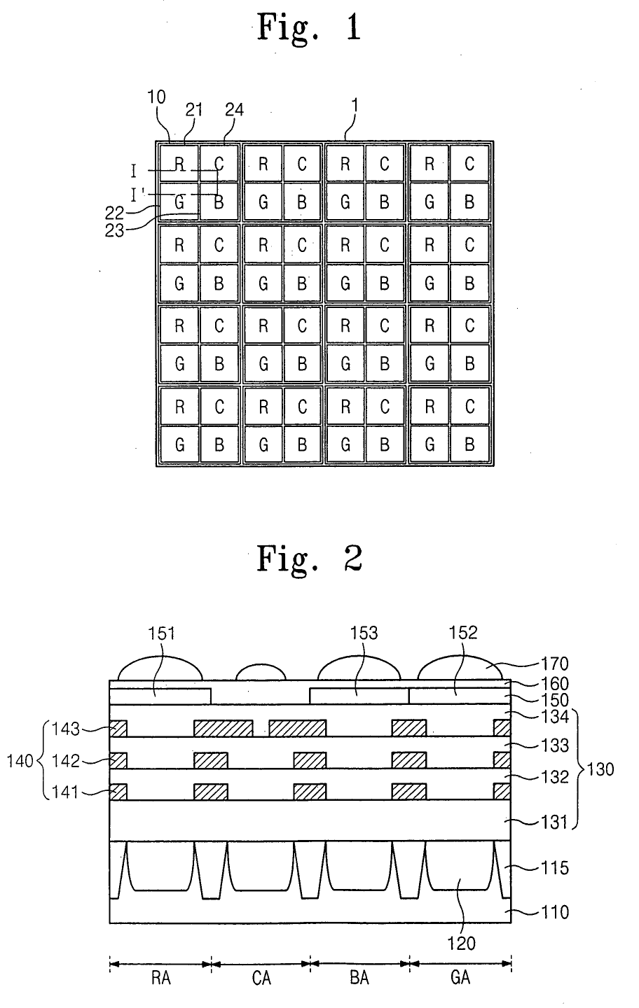

The figures referred to herein are drawn for clarity of illustration and are not necessarily drawn to scale. Elements having the same reference number in FIGS. 1, 2, 3, 4, 5, 6, and 7 refer to elements having similar structure and/or function.

### DETAILED DESCRIPTION OF THE INVENTION

Preferred embodiments of the present invention are now described below in more detail with reference to the accompanying drawings. The present invention may, however, be embodied in different forms and should not be construed as being limited to the embodiments set forth herein. Rather, these embodiments are provided so that this disclosure will be thorough and complete, and will fully convey the scope of the present invention to those skilled in the art.

Terms used herein such as ‘first’ and ‘second’ are used to indicate various elements, but the elements should not be limited by these terms. These terms are used to only discriminate the elements from one another. In the figures, the dimensions of layers and regions are exaggerated for clarity of illustration.

It will also be understood that when a layer (or film) is referred to as being ‘on’ another layer or substrate, it can be directly on the other layer or substrate, or intervening layers may also be present. Further, it will be understood that when a layer is referred to as being ‘under’ another layer, it can be directly under, or one or more intervening layers may also be present. In addition, it will also be understood that when a layer is referred to as being ‘between’ two layers, it can be the only layer between the two layers, or one or more intervening layers may also be present.

Referring to FIG. 1, each main pixel 10 includes a red (R) sub-pixel 21, a green (G) sub-pixel 22, and a blue (B) sub-pixel 23 for sensing the intensity of such respective color components. In addition, each main pixel 10 includes a compensation (C) sub-pixel 24. Such sub-pixels 21, 22, 23, and 24 form a square pattern of the main pixel 10 that is repeated in a matrix configuration to form an image sensor array for an image sensor 1, in an example embodiment of the present invention.

The red (R) sub-pixel 21 senses the red color component with a first sensitivity, and the green (G) sub-pixel 22 senses the green color component with a second sensitivity. The blue (B) sub-pixel 23 senses the blue color component with a third sensitivity, and the compensation sub-pixel 24 senses a respective color component with a fourth sensitivity.

According to an aspect of the present invention, the fourth sensitivity of the compensation sub-pixel 24 is less than each of the first, second, and third sensitivities of the red, green, and blue sub-pixels 21, 22, and 23. Thus, the dynamic range of the compensation sub-pixel 24 is extended at the high illumination range from each of the red, green, and blue sub-pixels 21, 22, and 23.

For example, referring to the cross-sectional view of the sub-pixels 21, 22, 23, and 24 in FIG. 2, a respective light receiving area of the compensation sub-pixel 24 is smaller than a respective light receiving area of each of the red, green, and blue sub-pixels 21, 22, and 23. Referring to FIG. 2, a semiconductor substrate 110 includes a red pixel area RA for forming the red sub-pixel 21 therein, a green pixel area GA for forming the green sub-pixel 22 therein, a blue pixel area BA for forming the blue sub-pixel 23 therein, and a compensation pixel area CA for forming the compensation sub-pixel 24 therein.

Each of the pixel areas RA, GA, BA, and CA includes a respective active region defined by a device isolation layer 115. Each of the pixel areas RA, GA, BA, and CA has a respective light receiving junction 120 formed in the respective active region of the semiconductor substrate 110. Each light receiving junction 120 is a photoelectric conversion area for converting incident light into signal charges for generating a respective image signal. Each light receiving junction 120 may be a photodiode formed as a PN junction by implanting a dopant of an opposite conduction type from the semiconductor substrate 110.

A plurality of interlayer dielectric layers 130 including a first dielectric layer 131, a second dielectric layer 132, a third dielectric layer 133, and a fourth dielectric layer 134 are sequentially formed on the substrate 110. Respective metal interconnections 140 are formed in the interlayer dielectric layers 130 including first interconnections 141 on the first dielectric layer 131, second interconnections 142 on the second dielectric layer 132, and third interconnections 143 on the third dielectric layer 133. Various transistors (not shown), for transferring signal charges generated from the light receiving junctions 120, are disposed in the first dielectric layer 131, and the metal interconnections 140 may be electrically connected to the transistors.

The interconnections 130 block light and are used to define the light receiving area of each of the sub-pixels 21, 22, 23, and 24. For example, the interconnection 143 disposed over the compensation pixel area CA extends inward over the respective light receiving junction 120 therein. Thus, the respective light receiving area within the compensation pixel area CA is smaller than the respective light receiving area of each of the other pixel areas RA, GA, and BA.

Accordingly, a respective amount of light reaching the respective light receiving junction 120 in the compensation pixel area CA is smaller than the respective amount of light reaching each of the pixel areas RA, GA, and BA. In an alternative embodiment of the present invention, other interconnections such as the first interconnections 141 and/or the second interconnections 142 in addition to or instead of the third interconnection 143 may extend inward in the compensation pixel area CA.

A color filter layer 150 is formed on the interlayer dielectric layers 130. The color filter layer 150 includes a red color filter 151, a green color filter 152, and a blue color filter 153 formed over the red, green, and blue pixel areas RA, GA, and BA, respectively. In the example embodiment of FIG. 2, no color filter is disposed over the compensation pixel area CA. In that case, the compensation sub-pixel 24 is a white pixel for sensing white light.

An overcoat layer 160 is disposed on the color filter layer 150. The overcoat layer 160 fills spaces over the compensation pixel area CA where a color filter is not formed 150.

A respective micro-lens 170 is formed on the overcoat layer 160 over each of the pixel areas RA, CA, GA, and BA. In the example embodiment of FIG. 2, the respective micro-lens 170 formed over the compensation pixel area CA is smaller than each of the respective micro-lenses 170 formed in the red, green, and blue pixel areas RA, GA, and BA. Accordingly, a respective light condensing rate of the smaller respective micro-lens 170 over the compensation pixel area CA is less than a respective light condensing rate of each of the micro-lenses 170 over the red, green, and blue pixel areas RA, GA, and BA. Thus, with the smaller light condensing rate, the amount of light incident to the respective light receiving junction 120 in the compensation pixel area CA is reduced.

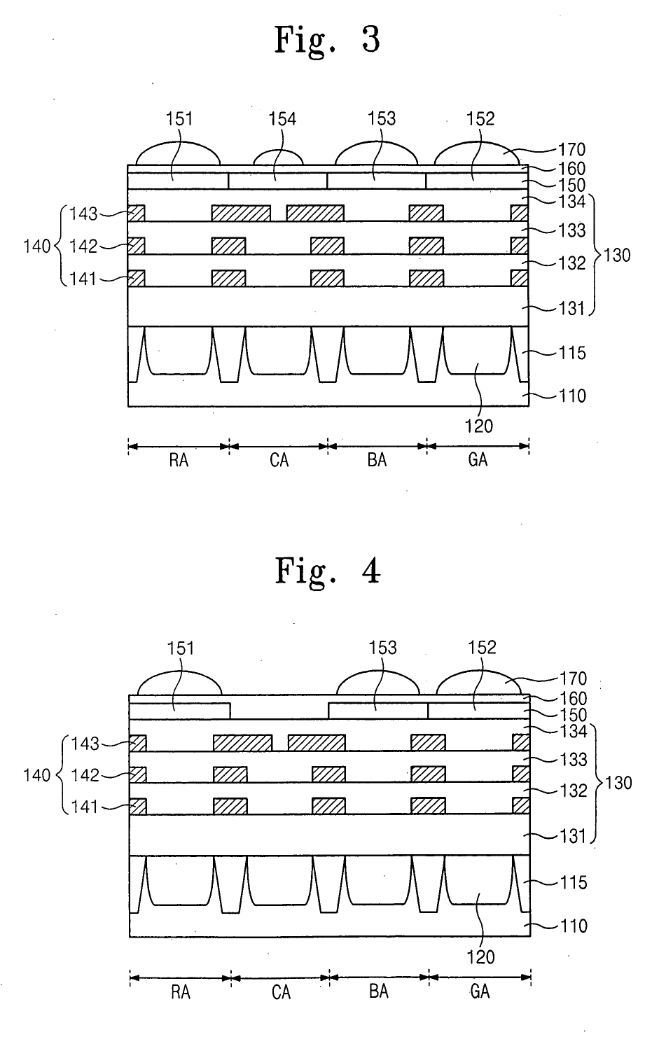

FIG. 3 shows a cross-sectional view of the sub-pixels 21, 22, 23, and 24 of FIG. 1 according to another embodiment of the present invention. Elements having the same reference number in FIGS. 2 and 3 refer to elements having similar structure and/or function, and a description thereof is omitted. In the example embodiment of FIG. 3, a respective color filter 154 is formed over the compensation pixel area CA. The respective color filter 154 for the compensation pixel area CA may be a red filter, a green filter, or a blue filter, and is the green filter for improving visibility. A respective amount of light reaching the respective light receiving junction 120 in the compensation pixel area CA is further reduced by forming the respective color filter 154.

FIG. 4 shows a cross-sectional view of the sub-pixels 21, 22, 23, and 24 of FIG. 1 according to another embodiment of the present invention. Elements having the same reference number in FIGS. 2 and 4 refer to elements having similar structure and/or function, and a description thereof is omitted. In the example embodiment of FIG. 4, a respective micro-lens is not formed in the compensation pixel area CA. In that case, light is not condensed to the respective light receiving junction 120 in the compensation pixel area CA. Thus, the respective amount of light reaching the respective light receiving junction 120 in the compensation pixel area CA is further reduced by eliminating the micro-lens over the compensation pixel area CA.

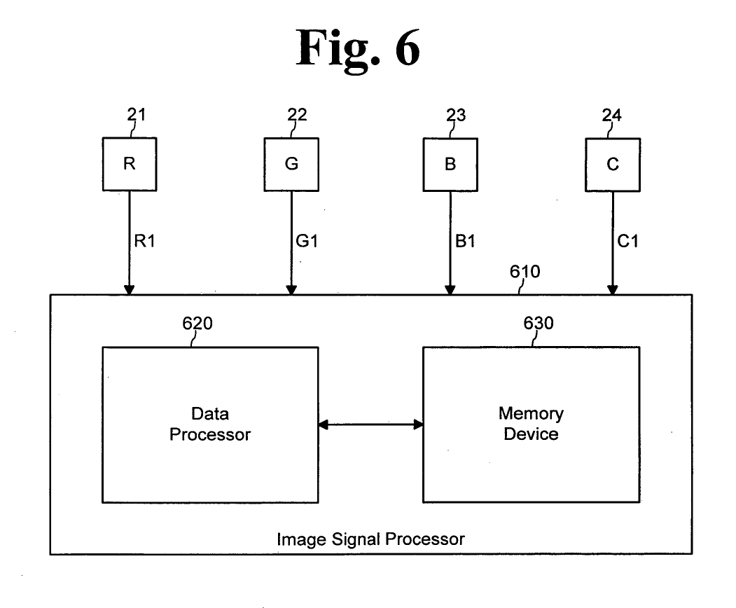

FIG. 6 shows an image signal processor 610 formed for the image sensor 10 of FIG. 1 for processing signals generated by each of the sub-pixels 21, 22, 23, and 24. The red sub-pixel 21 generates a first image signal R1 indicating an intensity of red light reaching the respective light receiving junction 120 in the red pixel area RA. The green sub-pixel 22 generates a second image signal G1 indicating an intensity of green light reaching the respective light receiving junction 120 in the green pixel area GA.

The blue sub-pixel 23 generates a third image signal B1 indicating an intensity of blue light reaching the respective light receiving junction 120 in the blue pixel area BA. The compensation sub-pixel 21 generates a fourth image signal C1 indicating an intensity of light reaching the respective light receiving junction 120 in the compensation pixel area CA.

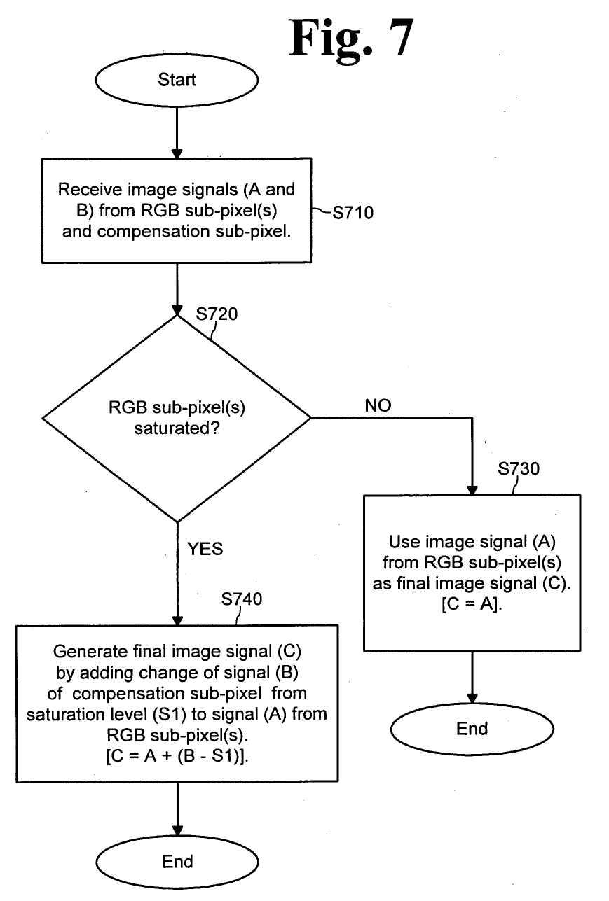

The image signal processor 610 includes a data processor 620 and a memory device 630 having sequences of instructions (i.e., software) stored thereon. Execution of such sequences of instructions by the data processor 620 causes the data processor 620 to perform the steps of the flowchart of FIG. 7.

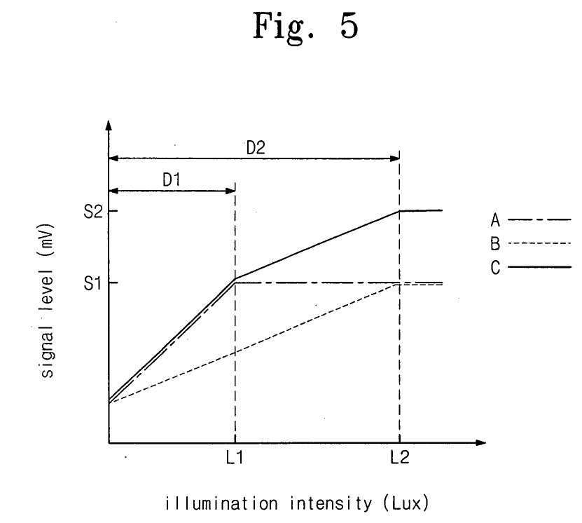

FIG. 5 shows a plot of example signal levels versus light intensity Lux to the image sensor 1 of FIG. 1, according to an example embodiment of the present invention. The light illumination intensity Lux is the intensity of light that the image sensor 1 is exposed to.

Referring to FIGS. 1 and 5, a semi-dashed line A in FIG. 5 is a respective image signal generated from at least one of the red, green and blue sub-pixels 21, 22, and 23. The image signal A may be a respective image signal from one of the red, green and blue sub-pixels 21, 22, and 23. Alternatively, the image signal A may be a sum of the respective signals from all of the red, green and blue sub-pixels 21, 22, and 23.

Additionally, a dashed line B in FIG. 5 is a respective image signal generated from the compensation sub-pixel 24. Furthermore, a solid line C in FIG. 5 indicates the level of a final image signal determined by the image signal processor 610 for at least one of the red, green and blue sub-pixels 21, 22, and 23 for the main pixel 10.

Referring to FIG. 5, note that the respective image signal A for the at least one of the red, green and blue sub-pixels 21, 22, and 23 increases until reaching a saturation level S1 at light illumination intensity L1 for a low dynamic range D1. In addition, since the amount of light reaching the light receiving junction 120 in the compensation sub-pixel 24 is smaller, the image signal B from the compensation sub-pixel 24 increases at lower levels and reaches the saturation level S1 at a higher light illumination intensity L2.

Referring to FIGS. 5, 6, and 7, operation of the image signal processor 610 begins by the data processor 620 receiving the image signal A from at least one of the RGB sub-pixels 21, 22, and 23 and the image signal B from the compensation sub-pixel 24 (step S710 of FIG. 7). In addition, the data processor 620 decides whether the at least one of the RGB sub-pixels 21, 22, and 23 corresponding to the signal A is saturated (step S720 of FIG. 7). If the signal A has reached the saturation level S1, then the at least one of the RGB sub-pixels 21, 22, and 23 corresponding to the signal A is determined to be saturated. If the signal A is less than the saturation level S1, then the at least one of the RGB sub-pixels 21, 22, and 23 corresponding to the signal A is determined to be not saturated.

If the at least one of the RGB sub-pixels 21, 22, and 23 corresponding to the signal A is determined to be not saturated, then the signal A itself is used as a final image signal C (step S730 of FIG. 7). If the at least one of the RGB sub-pixels 21, 22, and 23 corresponding to the signal A is determined to be saturated, then the final image signal for the main pixel 10 is determined by adding the change in the signal B from the saturation level S1 to the signal A (step S740 of FIG. 7). Another words in that case, the final image signal C may be expressed as follows:

C=[A+(B−S1)].

In the case that the signal A is for one of the RGB sub-pixels 21, 22, and 23, the steps S710, S720, S730, and S740 of FIG. 7 may be repeated for each respective image signal A of the RGB sub-pixels 21, 22, and 23 using the signal B of the compensation sub-pixel 24. Alternatively, in the case that the signal A is a sum of the respective image signals from all of the RGB sub-pixels 21, 22, and 23, the final image signal C is for the main pixel 10.

In this manner, the saturation level for the pixel 10 is extended to the higher saturation level S2 when the compensation sub-pixel C saturates at the higher illumination level L2. The image sensor 10 may be used to particular advantage in a vehicle. When a user drives a vehicle at night, an object illuminated brightly in the night may be recognized because the image sensor has an extended dynamic range D2 of FIG. 5 even when light of high illumination intensity is incident to the image sensor 10 from light of an adjacent vehicle.

While the present invention has been particularly shown and described with reference to an exemplary embodiment thereof, it will be understood by those of ordinary skill in the art that various changes in form and details may be made therein without departing from the spirit and scope of the present invention as defined by the following claims. For example, the saturation levels in the plots A, B, and C of FIG. 5 may be received from the sub-pixels 21, 22, 23, and 24 in analog form or digital form. The present invention is limited only as defined in the following claims and equivalents thereof.

What is claimed is:

1. An image sensor comprising:
a first sub-pixel for generating a first image signal with a first sensitivity;
a second sub-pixel for generating a second image signal with a second sensitivity less than the first sensitivity; and
an image signal processor for adding a change in the second image signal from a saturation level to the first image signal to generate a final image signal when the first sub-pixel is saturated.

2. The image sensor of claim 1, wherein the image signal processor includes:
a data processor; and
a memory device having sequences of instructions stored thereon, wherein execution of the sequences of instructions by the data processor causes the data processor to perform the steps of:
determining that the first sub-pixel is saturated when the first image signal reaches the saturation level; and
adding the change in the second image signal from the saturation level to the first image signal to generate the final image signal when the first sub-pixel is saturated.

3. The image sensor of claim 2, wherein execution of the sequences of instructions by the data processor causes the data processor to perform the further step of:
using the first image signal as the final image signal when the first sub-pixel is not saturated.

4. The image sensor of claim 3, wherein execution of the sequences of instructions by the data processor causes the data processor to perform the further step of:
determining that the first sub-pixel is not saturated when the first image signal is less than the saturation level.

5. The image sensor of claim 1, wherein a first light receiving area of the first sub-pixel is smaller than a second light receiving area of the second sub-pixel.

6. The image sensor of claim 5, wherein a first opening formed through a first interconnection over a first light receiving junction for the first sub-pixel is smaller than a second opening formed through a second interconnection over a second light receiving junction for the second sub-pixel.

7. The image sensor of claim 6, wherein light received by the second light receiving junction is of different color from light received by the first light receiving junction.

8. The image sensor of claim 6, further comprising:
a first light filter disposed over the first light receiving junction,
wherein no light filter is disposed over the second light receiving junction.

9. The image sensor of claim 6, further comprising:
a first light filter disposed over the first light receiving junction; and
a second light filter disposed over the second light receiving junction,
wherein the first and second light filters pass different color components.

10. The image sensor of claim 1, further comprising:
a first micro-lens formed for the first sub-pixel,
wherein no micro-lens is formed for the second sub-pixel.

11. The image sensor of claim 1, further comprising:
a first micro-lens formed for the first sub-pixel; and
a second micro-lens formed for the second sub-pixel,
wherein the first micro-lens has a first condensing rate that is higher than a second condensing rate of the second micro-lens.

12. The image sensor of claim 11, wherein a first size of the first micro-lens is larger than a second size of the second micro-lens.

13. The image sensor of claim 1, further comprising:
a third sub-pixel for generating a third image signal with a third sensitivity; and
a fourth sub-pixel for generating a fourth image signal with a fourth sensitivity;
wherein each of the third and fourth sensitivities is higher than the second sensitivity.

14. The image sensor of claim 13, wherein the first sub-pixel is for sensing red light, the second sub-pixel is for sensing one of white light and green light, the third sub-pixel is for sensing green light, and the fourth sub-pixel is for sensing blue light.

15. The image sensor of claim 14, wherein the image signal processor adds the change in the second image signal from the saturation level to the first image signal to generate a first final image signal when the first sub-pixel is saturated, and wherein the image signal processor adds the change in the second image signal from the saturation level to the third image signal to generate a third final image signal when the third sub-pixel is saturated, and wherein the image signal processor adds the change in the second image signal from the saturation level to the fourth image signal to generate a fourth final image signal when the fourth sub-pixel is saturated.

16. The image sensor of claim 13, wherein a pattern of the first, second, third, and fourth sub-pixels together forming a main pixel is repeated to form an image sensor array.

17. An image sensor comprising:
means for generating a first image signal with a first sensitivity;
means for generating a second image signal with a second sensitivity less than the first sensitivity; and
means for adding a change in the second image signal from a saturation level to the first image signal to generate a final image signal when the first sub-pixel is saturated.

18. The image sensor of claim 17, further comprising:
means for determining that the first sub-pixel is saturated when the first image signal reaches the saturation level;
means for using the first image signal as the final image signal when the first sub-pixel is not saturated; and
means for determining that the first sub-pixel is not saturated when the first image signal is less than the saturation level.

19. The image sensor of claim 17, wherein the means for generating the first image signal has a first light receiving area that is smaller than a second light receiving area for generating the second image signal.

20. The image sensor of claim 17, further comprising:
means for generating the first image signal by collecting light with a first condensing rate; and
means for generating the second image signal by collecting light with a second condensing rate that is less than the first condensing rate.
